(19) United States
(12) Patent Application Publication
(10) Pub. No.: US 2026/0010181 A1
(43) Pub. Date: Jan. 8, 2026

(54) METHOD OF CALCULATING AND AUTOMATING WASH WATER RATES FOR CRUDE DESALTING

(71) Applicant: Saudi Arabian Oil Company, Dhahran (SA)

(72) Inventors: Samusideen Adewale Salu, Ras Tanura (SA); Ali Mohammad Abbas, Ank (SA); Omar Ahmed Bahamdan, Dammam (SA)

(73) Assignee: Saudi Arabian Oil Company, Dhahran (SA)

(21) Appl. No.: 18/765,600

(22) Filed: Jul. 8, 2024

(51) Int. Cl. G05D 7/06; C10G 31/08

(52) U.S. Cl. CPC G05D 7/0635; C10G 31/08

(57) ABSTRACT

A method for automating wash water rates into a desalter comprises the steps of collecting historical dry crude rates; collecting historical wash water rates; collecting historical salt content amounts, where the historical dry crude rates, historical wash water rates, and historical salt content amounts are from a historical time period; determining a percent wash water from the historical wash water rates and historical dry crude rates; developing a salt content versus percent wash water curve using the historical salt content amounts and percent wash water; developing a salt content predictive equation from the salt content versus percent wash water curve; programming the salt content predictive equation and the percent wash water equation into a distributed control system; and regulating a current wash water rate based on an expected salt content determined from the salt content predictive equation.

### TECHNICAL FIELD

Disclosed are methods and systems for monitoring and controlling salt content in the gas oil separation plant. Specifically, disclosed are systems and methods for calculating the wash water injection rates for controlling salt content in the desalter of the gas oil separation plant.

### BACKGROUND

Raw wild crude produced from wells typically contains a mixture of gas, liquid hydrocarbons and salty formation water. In the upstream section of oil and gas processing, the function of a gas oil separation plant (GOSP) is to adequately separate gas and salty water from the crude oil to acceptable specifications for easy transportation and for downstream processing. For instance, excessive salt and water in crude oil from GOSP can result in high corrosion in transportation pipeline and refining units and will also have detrimental scaling effects on processing units and on catalysts.

As part of the gas oil separation plant (GOSP) operation, produced crude oil is separated from associated salty water in the wet crude handling facility (WCHF) including mainly crude dehydrator and desalter vessels. The salty water produced along with the crude often forms very tight emulsions with the oil that usually requires use of demulsifier chemicals and wash water to meet the required specifications. Produced crude oil from most GOSPs must meet a basic sediment and water (BS&W) specification and salt content specification to be acceptable to international crude buyers. Currently, in most GOSPs these crude product specifications are usually determined and monitored manually through laboratory analysis at every 8-hour shift interval. Similarly, the control of demulsifier and wash water injection rates are manually adjusted through the injection pump strokes at the field. Some GOSPs utilize ground water to be used as wash water while other GOSPs utilize treated seawater.

### SUMMARY

Disclosed are methods and systems for monitoring and controlling salt content in the gas oil separation plant. Specifically, disclosed are systems and methods for calculating the wash water injection rates for controlling salt content in the desalter of the gas oil separation plant.

In as first aspect, a method for automating wash water rates into a desalter is provided. The method includes the steps of collecting historical dry crude rates, collecting historical wash water rates, collecting historical salt content amounts, where the historical dry crude rates, historical wash water rates, and historical salt content amounts are from a historical time period, determining a percent wash water from the historical wash water rates and historical dry crude rates, developing a salt content versus percent wash water curve using the historical salt content amounts and percent wash water, developing a salt content predictive equation from the salt content versus percent wash water curve, programming the salt content predictive equation and the percent wash water equation into a distributed control system, and regulating a current wash water rate based on an expected salt content determined from the salt content predictive equation and the percent wash water equation.

In certain aspects, the salt content amounts are measured in pounds of salt per thousand barrels (PTB). In certain aspects, dry crude rates, wash water rates, and salt content amounts from a plurality of historical time periods are collected such that one salt content versus percentage wash water curve is developed for each historical time period. In certain aspects, the salt content predictive equation is a best fit polynomial of the salt content amount percent wash water curve. In certain aspects, the step of regulating the current the wash water rate includes maintaining the current wash water rate when the expected salt content meets a specified target. In certain aspects, the step of regulating the current wash water rate includes modifying the current wash water rate when the expected salt content does not meet a specified target. In certain aspects, the step of regulating the current wash water rate based on the expected salt content further includes the steps of reading a current dry crude rate from a crude flow transmitter, reading the current wash water rate from a water flow transmitter, determining a current percent wash water using the percent wash water equation and the current dry crude rate and current wash water rate, determining an expected salt content from the salt content predictive equation, and comparing the expected salt content to a specified target, where the action on the current wash water rate is selected from the group consisting of maintaining the current wash water rate and modifying the current wash water rate. In certain aspects, the method further includes the step of sampling the salt content exiting the desalter. In certain aspects, the method further includes the step of developing a plurality of salt content versus percentage wash water curves, where each salt content versus percentage wash water curve represents a different time period. In certain aspects, the method further includes the step of selecting the salt content versus percentage wash water curve in the distributed control system from the plurality of salt content versus percentage wash water curves, where the step of selecting is performed manually.

In a second aspect a method for automating wash water injection rates in a desalter is provided. The method includes the steps of reading a current dry crude rate from a crude flow transmitter, reading a current wash water rate from a water flow transmitter, determining a current percent wash water from the current dry crude rate and current wash water rate, determining an expected salt content using the current percent wash water and a salt content versus percent wash water curve, comparing the expected salt content to a specified target, modifying the current wash water rate by adjusting a flow control valve to produce a modified wash water rate when the expected salt content does not meet the specified target, and maintaining the modified wash water rate for a run time.

In certain aspects, determining the current percent wash water includes determining the percent wash water according to the following P=W×100/C where P is the percent wash water, W is the current wash water rate in thousands of barrels per day (MBD), and C is current dry crude in thousands of barrels per day (MBD). In certain aspects, the step of determining an expected salt content further includes the steps of collecting historical dry crude rates, collecting historical wash water rates, collecting historical salt content amounts, where the historical dry crude rates, historical wash water rates, and historical salt content amounts are from a historical time period, determining a percent wash water from the historical wash water rates and historical dry crude rates, developing a salt content versus percent wash water curve using the historical salt content amounts and percent wash water, determining a best fit polynomial of the salt content versus percent wash water curve, and using the best fit polynomial to determine the expected salt content. In certain aspects, the method further includes the step of programming the best fit polynomial and the percent wash water equation into a distributed control system, where the distributed control system controls the flow control valve.

In a third aspect, a system for automating a wash water rate in a desalter is provided. The system includes a distributed control system operatively coupled to a flow control valve, and a non-transitory computer-readable medium in communication with the distributed control system and having stored thereon a set of instructions that when executed cause the distributed control system to perform operations includes reading a current dry crude rate from a crude flow transmitter, reading a current wash water rate from a water flow transmitter, determining a current percent wash water from the current dry crude rate and current wash water rate, determining an expected salt content using the current percent wash water and a salt content versus percent wash water curve, comparing the expected salt content to a specified target, determining a modified wash water rate when the expected salt content does not meet the specified target, adjusting the flow control valve to produce the modified wash water rate, and maintaining the modified wash water rate for a run time.

In certain aspects, the desalter is in the absence of an online salt analyzer. In certain aspects, the run time is the residence time of the desalter. In certain aspects, the specified target is between 9.6 pounds per thousand barrels and 9.8 pounds per thousand barrels. In certain aspects, the method further includes the step of using a best fit polynomial of the salt content versus percent wash water curve to determine the expected salt content.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIG. 1 is a process flow diagram of gas oil separation plant.

FIG. 2 is graphic representation of a salt content versus % wash water curve with different scenarios.

FIG. 3 is a flow diagram of an embodiment method for adjusting the wash water rate in the desalter.

In the accompanying Figures, similar components or features, or both, may have a similar reference label.

### DETAILED DESCRIPTION

While the scope of the apparatus and method will be described with several embodiments, it is understood that one of ordinary skill in the relevant art will appreciate that many examples, variations and alterations to the apparatus and methods described here are within the scope and spirit of the embodiments.

Accordingly, the embodiments described are set forth without any loss of generality, and without imposing limitations, on the embodiments. Those of skill in the art understand that the scope includes all possible combinations and uses of particular features described in the specification.

The systems and methods provide a method for automating wash water rates to be injected into the desalter of the gas oil separation plant. The method provides automating wash water injection rates based on historical data to develop predictive relationships. The predictive relationships in the form of equations can be programmed into the distributed control system (DCS). Advantageously, the method automates wash water injection rates. Advantageously, the method automates wash water injection rates by predicting the wash water injection rate based on historical data. Advantageously, the systems and methods reduce the amount of water used as wash water, enhance salt specification monitoring and control and save energy and cost by optimizing water rates without the need of additional equipment. Advantageously, the method for automating wash water rates can be performed in real time to adjust to changes in the salt content of the crude oil.

As used throughout, “dry crude rates” refers to the flow rate of dry crude in thousand barrels per day (MBD) from the crude stabilizer column.

As used throughout, “wash water rates” or “wash water injection rate” refers to the flow rate of wash water into the desalter in thousands of barrels per day (MBD).

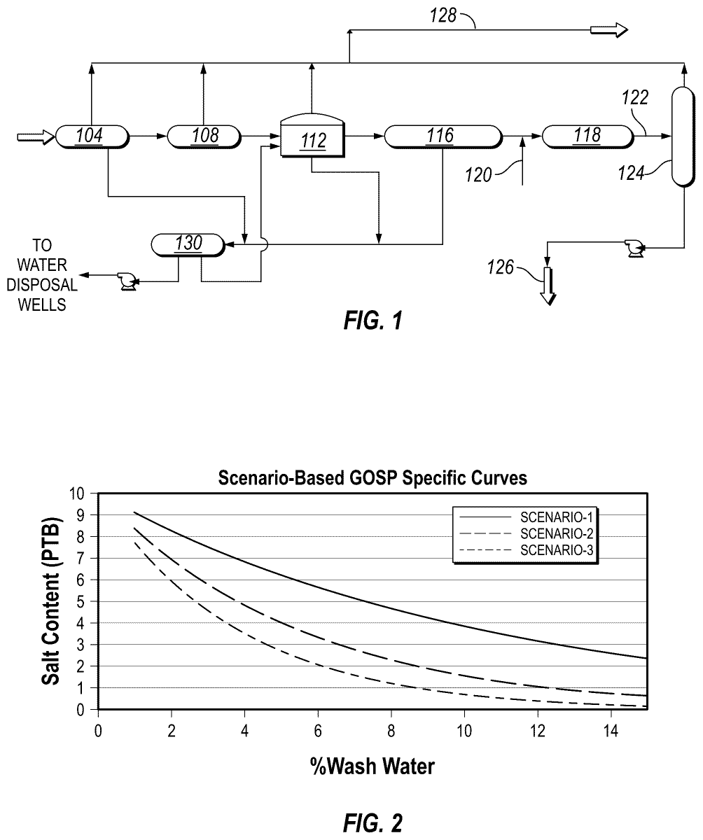

Referring to FIG. 1, a process flow diagram of a typical gas oil separation plant (GOSP) is provided. The GOSP receives wild crude 102 from upstream field and feeds wild crude 102 into high pressure production trap (HPPT) 104, a three-phase separator, where the first stage of gas and free water separation from the crude takes place. Separated wet crude 106 from HPPT 104 is fed into a second stage, two or three-phase separation vessel, low pressure production trap (LPPT) 108, where further separation of gas and water, in the case of three phase separation vessel, from the crude at a lower pressure occurs. Wet crude 110 is fed into low pressure degassing tanks (LPDT) 112, a three-phase separator that normally operates at near atmospheric pressure to remove further gas and water from the wet crude. Wet crude oil 114 from LPDT 112 is transferred by crude charge pumps (not shown) to the wet crude handling facility (WCHF), which includes dehydrator 116 and desalter 118. Wet crude oil 22 can be treated in the WCHF with wash water 120 to meet the basic sediment and water (BS&W) specification and salt content specification. Dehydrated/desalted crude 122 then flows to crude stabilizer column 124 where it is stripped of volatile components and stabilized for export as export grade crude 126. The gas streams from HPPT 104, LPPT 108, LDPT 112, and crude stabilizer column 124 flow as associated gas 128 to the gas processing plant, while water is pumped to water oil separator (WOSEP) 130 to remove the oil content to meet required specifications before it is injected back into the reservoir for water-flooding and pressure maintenance. One of skill in the art will appreciate that additional units can be included in GOSP configurations, such as a wet/dry heat exchanger (not shown) upstream of LPDT 18 and an additional LPDT (not shown), and that the inclusion of such units do not impact the operation of the desalter or the methods disclosed herein.

As part of the method for automating wash water injection rates, the programmable parameters and equations must be determined. To determine these equations, first historical data is collected. The data collected includes dry crude rates, wash water rates, and salt content amounts measured in pounds per thousand barrels (PTB). The salt content is measured in the outlet of the desalter. The historical data is collected for the specific GOSP and specific desalter within the GOSP for which the wash water injection rate is to be automated. One of skill in the art will appreciate that GOSPs vary in their crude oil feed, design parameters, and operating conditions and the historical data from one GOSP may not be predictive of another. Advantageously, the method for automating wash water injection rates produces a highly customizable and tailored result that is responsive to the specific GOSP. Advantageously, the method for automating wash water injection rates can be tailored to the crude oil feed, to the season and rainfall patterns, and to the lifecycle of the desalters.

The historical data can be collected from available system data based on readings from instrumentation in the case of dry crude rates and wash water rates and measured lab results in the case of salt content. The instrumentation can include flow transmitters. The historical data of all three parameters are pulled from the same historical time period. The historical data can be collected manually or can be collected by pulling the data from the DCS. The historical time period selected should be represented of plant operations and in the event multiple curves are to be developed, the historical data should represent multiple historical time periods. The historical time period or historical time periods can be months or years.

In a next step, the percent wash water is calculated using the wash water rates and dry crude rates according to equation 1:

$$P = W \times 100 / C \qquad Equation 1$$

where, P is percent wash water, W is wash water rate in thousands of barrels per day (MBD) and C is dry crude rate in thousands of barrels per day (MBD).

In a third step, the salt content amounts collected in the first step is plotted against the percent wash water calculated in step two to establish a salt content versus % wash water curve. An example of the salt content versus % wash water graph is shown in FIG. 2. This graph shows multiple curves for different scenarios, where each scenario corresponds to a different set of historical data from step one.

In a fourth step, salt content predictive equations can be determined from the salt content versus % wash water curves. A salt content predictive equation for each curve can be determined based on a best fit polynomial taking the form of equation 2:

$$y = {ax}^{d} - bx + c \qquad Equation 2$$

where y is a value on the y-axis and x is a value on the x-axis of the salt content versus % wash water curve and a, b, c, and d are values that will be determined based on the best fit of the data.

In a fifth step, the one or more salt content predictive equations can be programmed into the DCS of the GOSP along with the percent wash water equation, equation 1. In an embodiment where more than one salt content predictive equations is determined, each equation can be identified based on the circumstances, for example the season or the specific desalter in a GOSP with more than one such that the equations can be selected as needed for the appropriate operating scenario of the GOSP.

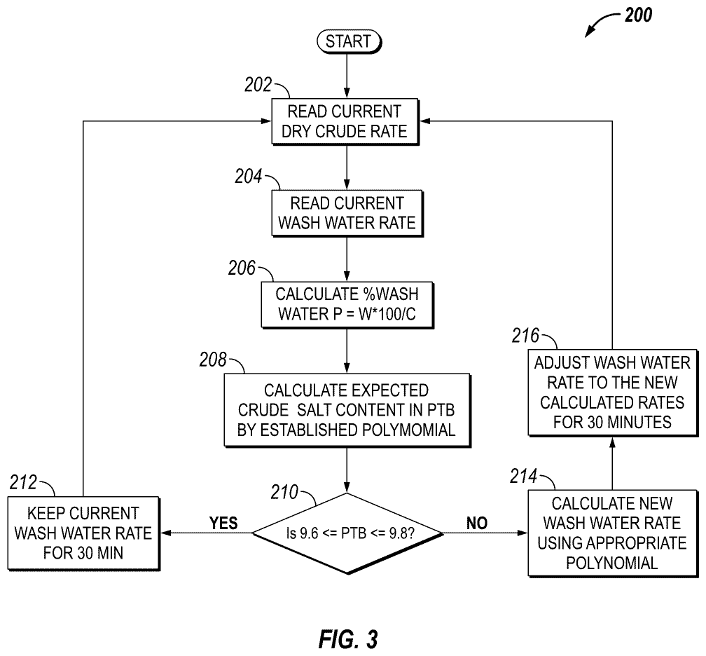

Once programmed into the DCS, the salt content predictive equation can be used to automate the wash water injection rates according to the method shown in FIG. 3. FIG. 3 is a flow diagram illustrating the steps of the method to automate wash water rates 200. In step 202, the DCS reads the current dry crude rate. In step 204, the DCS reads the current wash water rate. Both the current dry crude rate and wash water rate can be read from instrumentation installed on those transfer lines. In at least one embodiment, the dry crude rate is read from a crude flow transmitter. In at least one embodiment, the wash water rate is read from a water flow transmitter.

In step 206, the DCS calculates the current % wash water from the percent wash water equation. In step 208, the DCS calculates the expected salt content from the salt content predictive equation selected for the current GOSP scenario. In step, 210 the expected salt content can be compared to a specified target. In at least one embodiment, the specified target for the salt content is less than 10 pounds per thousand barrels (PTB) (28.55 mg/L), alternately between 9.6 PTB (27.408 mg/L) and 9.8 PTB (27.979 mg/L). The results from the DCS can enable one to regulate or control the current wash water rate. Regulating or controlling the current wash water rate can include maintaining the current wash water rate or modifying the wash water rate. If the expected salt content is within the specified target, then the current wash water rate can be maintained at the current rate for a run time as shown in step 212. The run time can be the residence time of the desalter or some other time as required by the GOSP operating conditions. After the run time, the method can begin at the first step.

If the expected salt content is not within the specified target as calculated in step 208, then a modified wash water rate can be calculated backward from the salt content predictive equation as in step 214. In step 216, the current wash water rate can be adjusted to match the modified wash water rate and can be maintained for the run time. The wash water rate can be adjusted using the flow control valve. After the run time, the method can begin at the first step. In the Example shown in FIG. 3, the run time was 30 minutes. However, the run time can be determined based on the operating conditions of the desalter and the GOSP.

In an alternate step, the salt content out of the desalter can be verified by measurement of lab samples.

A console operate can shift between the one or more salt content predictive equations programmed into DCS to reflect the GOSP operating conditions.

Advantageously, the methods and systems to automate wash water injection rates do not require added equipment or instrumentation and can utilize the currently installed equipment and instrumentation. Advantageously, the methods and systems to automate wash water rates require only modifying one operating parameter in the GOSP, the wash water injection rate to impact the salt content.

The methods and systems to automate wash water rates are in the absence of online salt analyzers. The methods and systems to automate wash water rates are in the absence of data about the crude oil feed.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

There various elements described can be used in combination with all other elements described here unless otherwise indicated.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed here as from about one particular value to about another particular value and are inclusive unless otherwise indicated. When such a range is expressed, it is to be understood that another embodiment is from the one particular value to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references contradict the statements made here.

As used here and in the appended claims, the words “comprise,” “has,” and “include” and all grammatical variations thereof are each intended to have an open, non-limiting meaning that does not exclude additional elements or steps.

That which is claimed is:

1. A method for automating wash water rates into a desalter comprises the steps of:
collecting historical dry crude rates;
collecting historical wash water rates;
collecting historical salt content amounts, where the historical dry crude rates, historical wash water rates, and historical salt content amounts are from a historical time period;
determining a percent wash water from the historical wash water rates and historical dry crude rates;
developing a salt content versus percent wash water curve using the historical salt content amounts and percent wash water;
developing a salt content predictive equation from the salt content versus percent wash water curve;
programming the salt content predictive equation and the percent wash water equation into a distributed control system; and
regulating a current wash water rate based on an expected salt content determined from the salt content predictive equation

2. The method of claim 1, where the salt content amounts are measured in pounds per thousand barrels (PTB).

3. The method of claim 1, where dry crude rates, wash water rates, and salt content amounts from a plurality of historical time periods are collected such that one salt content versus percentage wash water curve is developed for each historical time period.

4. The method of claim 1, where the salt content predictive equation is a best fit polynomial of the salt content amount percent wash water curve.

5. The method of claim 1, where the step of regulating the current the wash water rate comprises maintaining the current wash water rate when the expected salt content meets a specified target.

6. The method of claim 1, where the step of regulating the current wash water rate comprises modifying the current wash water rate when the expected salt content does not meet a specified target.

7. The method of claim 1, where the step of regulating the current wash water rate based on the expected salt content further comprises the steps of:
reading a current dry crude rate from a crude flow transmitter;
reading the current wash water rate from a water flow transmitter;
determining a current percent wash water using the percent wash water equation and the current dry crude rate and current wash water rate;
determining an expected salt content from the salt content predictive equation; and
comparing the expected salt content to a specified target, where the action on the current wash water rate is selected from the group consisting of maintaining the current wash water rate and modifying the current wash water rate.

8. The method of claim 1, further comprising the step of sampling the salt content exiting the desalter.

9. The method of claim 1, further comprising the step of developing a plurality of salt content versus percentage wash water curves, where each salt content versus percentage wash water curve represents a different time period.

10. The method of claim 9, further comprising the step of selecting the salt content versus percentage wash water curve in the distributed control system from the plurality of salt content versus percentage wash water curves, where the step of selecting is performed manually.

11. A method for automating wash water injection rates in a desalter, the method comprising the steps of:
reading a current dry crude rate from a crude flow transmitter;
reading a current wash water rate from a water flow transmitter;
determining a current percent wash water from the current dry crude rate and current wash water rate;
determining an expected salt content using the current percent wash water and a salt content versus percent wash water curve;
comparing the expected salt content to a specified target;
modifying the current wash water rate by adjusting a flow control valve to produce a modified wash water rate when the expected salt content does not meet the specified target; and
maintaining the modified wash water rate for a run time.

12. The method of claim 11, where determining the current percent wash water comprises determining the percent wash water according to the following P=W×100/C where P is the percent wash water, W is the current wash water rate in thousands of barrels per day (MBD), and C is current dry crude in thousands of barrels per day (MBD).

13. The method of claim 11, where the step of determining an expected salt content further comprises the steps of:
collecting historical dry crude rates;
collecting historical wash water rates;
collecting historical salt content amounts, where the historical dry crude rates, historical wash water rates, and historical salt content amounts are from a historical time period;
determining a percent wash water from the historical wash water rates and historical dry crude rates;
developing a salt content versus percent wash water curve using the historical salt content amounts and percent wash water;
determining a best fit polynomial of the salt content versus percent wash water curve; and
using the best fit polynomial to determine the expected salt content.

14. The method of claim 12, further comprising the step of programming the best fit polynomial and the percent wash water equation into a distributed control system, where the distributed control system controls the flow control valve.

15. A system for automating a wash water rate in a desalter, the system comprising:
a distributed control system operatively coupled to a flow control valve; and
a non-transitory computer-readable medium in communication with the distributed control system and having stored thereon a set of instructions that when executed cause the distributed control system to perform operations comprising:
reading a current dry crude rate from a crude flow transmitter;
reading a current wash water rate from a water flow transmitter;
determining a current percent wash water from the current dry crude rate and current wash water rate;
determining an expected salt content using the current percent wash water and a salt content versus percent wash water curve;
comparing the expected salt content to a specified target;
determining a modified wash water rate when the expected salt content does not meet the specified target;
adjusting the flow control valve to produce the modified wash water rate; and
maintaining the modified wash water rate for a run time.

16. The system of claim 15, where the desalter is in the absence of an online salt analyzer.

17. The system of claim 15, where the run time is the residence time of the desalter.

18. The system of claim 15, where the specified target is between 9.6 pounds per thousand barrels and 9.8 pounds per thousand barrels.

19. The system of claim 15, further comprising the step of using a best fit polynomial of the salt content versus percent wash water curve to determine the expected salt content.
